(19) United States
(12) Patent Application Publication
(10) Pub. No.: US 2017/0212286 A1
(43) Pub. Date: Jul. 27, 2017

(54) THERMOPLASTIC PANEL TO SHIFT PERCEPTION OF COLOR TEMPERATURE OF LIGHT EMITTING DIODES

(71) Applicant: PolyOne Corporation, Avon Lake, OH (US)

(72) Inventors: David PERSING, North Ridgeville, OH (US); David D. ERTLE, Canal Fulton, OH (US); Saleem SHAKIR, Westlake, OH (US); James STEPHENSON, Hoover, AL (US)

(73) Assignee: PolyOne Corporation, Avon Lake, OH (US)

(21) Appl. No.: 15/515,009

(22) PCT Filed: Oct. 5, 2015
(86) PCT No.: PCT/US15/54070

§ 371 Date: Mar. 28, 2017

Related U.S. Application Data
(60) Provisional application No. 62/061,879, filed on Oct. 9, 2014.

(51) Int. Cl. G02B 5/22; F21V 9/08; F21S 10/02; G02B 1/04; G02B 5/02; H05B 33/20

(52) U.S. Cl. CPC G02B 5/223; G02B 5/0278; G02B 5/0236; H05B 33/20; F21S 10/02; G02B 5/0294; G02B 1/04; F21V 9/08

(57) ABSTRACT

Color temperature actually emitted by a light emitting diode (LED) is perceived by a viewer of that LED to be altered because of the placement of a passive color temperature-shifting panel between the viewer and the LED. The panel is colored in a manner to cause a perception of a shift from one color temperature of the light emitting diode to another color temperature of the light emitting diode in the absence of any electrochromic, photochromic, or thermochromic material in the panel.

### CLAIM OF PRIORITY

This application claims priority from U.S. Provisional Patent Application Ser. No. 62/061,879 bearing Attorney Docket Number 12014016 and filed on Oct. 9, 2014, which is incorporated by reference.

### FIELD OF THE INVENTION

This invention relates to a method to adjust the perception of the color temperature of light emitting diodes by use of a thermoplastic panel intermediate between the light emitting diodes and a viewer of light from such light emitting diodes.

### BACKGROUND OF THE INVENTION

Light emitting diodes (“LEDs”) are rapidly becoming popular for interior and exterior lighting because of their lower energy consumption as compared with incandescent lamps.

LEDs are produced in commercial quantities at a variety of color temperatures. A typical display of LEDs on sale in a commercial retail store includes LEDs in the range of “Soft White” (2700 K); “Warm White” (3000 K); “Bright White” (3500 K); and “Daylight” (5000 K), where the color temperature from 2700-5000 is measured in degrees Kelvin.

There are differences in costs of manufacture of LEDs because of the differences in color temperature to be achieved. For example, general purpose, high brightness LEDs having a color temperature of about 3500 K are less expensive to produce than LEDs having a color temperature of about 2700 K. But the “Bright White” color temperature might be less desirable than the “Soft White” color temperature.

It is known in the art that there is a desire to adjust color temperature for LEDs, such as disclosed in U.S. Pat. No. 8,801,220. It is also known in the art that a layer of material between light source and viewer can be a passive color filter, such U.S. Published Patent Application 20070132371. But both of these approaches rely on an expensive electrochromic layer or other element in the assembly, in order to permit adjustment or tuning of the color temperature of light from the LED from that which is emitted to that which is viewed.

### SUMMARY OF THE INVENTION

What the art needs is a material which can be inexpensively made and used to adjust or tune the color temperature of the LED from the actual color temperature emitted by the LED to the desired color temperature as perceived by a viewer of that LED.

It has been found in this invention that one does not need tunable electrochromic, photochromic, or thermochromic layers and their associated expense, if one is willing to utilize a passive layer having a pre-determined color to provide a shift in perceived color temperature from a different color temperature as actually emitted by the LED.

One aspect of the present invention is a panel comprising a thermoplastic resin and at least one colorant, wherein the panel is translucent and intermediate between a light emitting diode and a viewer of the light emitting diode, and wherein the panel is colored in a manner to cause a perception of a shift from an actual color temperature of the light emitting diode to another color temperature perceived by the viewer in the absence of any electrochromic, photochromic, or thermochromic material in the panel.

As one embodiment, it is possible for colorant(s) to be selected for use in the thermoplastic panel to alter the actual color temperature of a less expensive LED to become a perceived color temperature of a more expensive LED. In that manner, one can reduce the cost of providing a specific color temperature by use of the intermediate panel of pre-determined color described above.

### EMBODIMENTS OF THE INVENTION

### Thermoplastic Resin

Any thermoplastic resin capable of translucency in the shape of panel is a candidate for use in this invention. Desirable candidate resins include polyolefins, polyesters, polyacrylics, styrenics, polyamides, polyvinyl halides, etc. Preferred candidate resins are polyvinyl halides because of their inherent transparency and suitability for compounding with other materials for affecting the degree of light transmission and translucency.

Polyvinyl chloride polymers are widely available throughout the world. Polyvinyl chloride resin (PVC) as referred to herein includes polyvinyl chloride homopolymers, vinyl chloride copolymers, graft copolymers, and vinyl chloride polymers polymerized in the presence of any other polymer such as a heat distortion temperature enhancing polymer, impact toughener, barrier polymer, chain transfer agent, stabilizer, plasticizer or flow modifier.

For example a combination of modifications may be made with the PVC polymer by overpolymerizing a low viscosity, high glass transition temperature (Tg) enhancing agent such as SAN resin, or an imidized polymethacrylate in the presence of a chain transfer agent.

In another alternative, vinyl chloride may be polymerized in the presence of said Tg enhancing agent, the agent having been formed prior to or during the vinyl chloride polymerization. However, only those resins possessing the specified average particle size and degree of friability exhibit the advantages applicable to the practice of the present invention.

In the practice of the invention, there may be used polyvinyl chloride homopolymers or copolymers of polyvinyl chloride comprising one or more comonomers copolymerizable therewith. Suitable comonomers for vinyl chloride include acrylic and methacrylic acids; esters of acrylic and methacrylic acid, wherein the ester portion has from 1 to 12 carbon atoms, for example methyl, ethyl, butyl and ethylhexyl acrylates and the like; methyl, ethyl and butyl methacrylates and the like; hydroxyalkyl esters of acrylic and methacrylic acid, for example hydroxymethyl acrylate, hydroxyethyl acrylate, hydroxyethyl methacrylate and the like; glycidyl esters of acrylic and methacrylic acid, for example glycidyl acrylate, glycidyl methacrylate and the like; alpha, beta unsaturated dicarboxylic acids and their anhydrides, for example maleic acid, fumaric acid, itaconic acid and acid anhydrides of these, and the like; acrylamide and methacrylamide; acrylonitrile and methacrylonitrile; maleimides, for example, N-cyclohexyl maleimide; olefin, for example ethylene, propylene, isobutylene, hexene, and the like; vinylidene chloride, for example, vinylidene chloride; vinyl ester, for example vinyl acetate; vinyl ether, for example methyl vinyl ether, allyl glycidyl ether, n-butyl vinyl ether and the like; crosslinking monomers, for example diallyl phthalate, ethylene glycol dimethacrylate, methylene bis-acrylamide, tracrylyl triazine, divinyl ether, allyl silanes and the like; and including mixtures of any of the above comonomers.

The present invention can also use chlorinated polyvinyl chloride (CPVC), wherein PVC containing approximately 57% chlorine is further reacted with chlorine radicals produced from chlorine gas dispersed in water and irradiated to generate chlorine radicals dissolved in water to produce CPVC, a polymer with a higher glass transition temperature (Tg) and heat distortion temperature. Commercial CPVC typically contains by weight from about 58% to about 70% and preferably from about 63% to about 68% chlorine. CPVC copolymers can be obtained by chlorinating such PVC copolymers using conventional methods such as that described in U.S. Pat. No. 2,996,489, which is incorporated herein by reference. Commercial sources of CPVC include Lubrizol Corporation.

The preferred composition is a polyvinyl chloride homopolymer.

Commercially available sources of polyvinyl chloride polymers include OxyVinyls LP of Dallas, Tex. and Shintech USA of Freeport, Tex.

### Compounds of Resins

Thermoplastic resin compounds typically contain a variety of additives selected according to the performance requirements of the article produced therefrom well within the understanding of one having ordinary skill in the art without the necessity of undue experimentation.

Using PVC as only one possible embodiment, PVC compounds suitable for use in this invention can contain effective amounts of additives ranging from 0.01 to about 500 weight parts per 100 weight parts of PVC (parts per hundred resin or “phr”).

For example, various primary and/or secondary lubricants such as oxidized polyethylene, paraffin wax, fatty acids, and fatty esters and the like can be utilized.

Thermal and ultra-violet light (UV) stabilizers can be utilized such as various organo tins, for example dibutyl tin, dibutyltin-S-S′-bi-(isooctylmercaptoacetate), dibutyl tin dilaurate, dimethyl tin diisooctylthioglycolate, mixed metal stabilizers like Barium Zinc and Calcium Zinc, and lead stabilizers (tri-basic lead sulfate, di-basic lead phthalate, for example). Secondary stabilizers may be included for example a metal salt of phosphoric acid, polyols, and epoxidized oils. Specific examples of salts include water-soluble, alkali metal phosphate salts, disodium hydrogen phosphate, orthophosphates such as mono-, di-, and tri-orthophosphates of said alkali metals, alkali metal polyphosphates, -tetrapolyphosphates and -metaphosphates and the like. Polyols such as sugar alcohols, and epoxides such as epoxidized soybean oil can be used. Typical levels of secondary stabilizers range from about 0.1 wt. parts to about 10.0 wt. parts per 100 wt. parts PVC (phr).

In addition, antioxidants such as phenolics, BPA, BHT, BHA, various hindered phenols and various inhibitors like substituted benzophenones can be utilized.

Various processing aids, fillers, flame retardants and reinforcing materials can also be utilized in amounts up to about 200 or 300 phr. Exemplary processing aids are acrylic polymers such as poly methyl (meth)acrylate based materials.

Adjustment of melt viscosity can be achieved as well as increasing melt strength by employing 0.5 to 5 phr of commercial acrylic process aids such as those from Rohm and Haas under the Paraloid® trademark. Paraloid®. K-120ND, K-120N, K-175, and other processing aids are disclosed in The Plastics and Rubber Institute: International Conference on PVC Processing, Apr. 26-28 (1983), Paper No. 17.

Examples of fillers include calcium carbonate, clay, silica and various silicates, talc, carbon black and the like. Reinforcing materials include glass fibers, polymer fibers and cellulose fibers. Such fillers are generally added in amounts of from about 3 to about 500 phr of PVC. Preferably from 3 to 300 phr of filler can be employed. Also, flame retardant fillers like ATH (Aluminum trihydrates), AOM (ammonium octamolybdate), antimony trioxides, magnesium oxides and zinc borates are added to boost the flame retardancy of polyvinyl chloride. The concentrations of these fillers range from 1 phr to 200 phr.

Of all possible thermoplastic compounds, Geon™ M7500 polyvinyl chloride polymer compound is presently preferred for use in making panels of this invention.

### Colorants

Colorant can be a pigment, a dye, a combination of pigments, a combination of dyes, a combination of pigments and dye, a combination of pigment and dyes, or a combination of pigments and dyes. The choice of colorants depends on the ultimate color desired by the designer of the panel for color temperature shifting in the panel. Pigments are preferred for durability to resist discoloration because of exposure to ultraviolet light.

The science of color is well known to those skilled in the art. Without undue experimentation, one can use color matching techniques to identify a particular location in spherical color space. For example, one skilled in the art can use the teachings of PCT Publication WO 2004/095319 to digitally map color space using specific polymer carriers and colorants as raw material ingredients. Alternatively, one can make small samples called plaques for visual review.

Colorants are commercially available from a number of sources well known to those skilled in the art. Commercially available pigments include organic and inorganic colorant chemistries. Commercially available dyes include all organic chemistries. Commercial sources for pigments and dyes include multinational companies such as BASF, Bayer, Clariant, Color-Chem International, Sun Chemical, Zhuhai Skyhigh Chemicals, and others.

The amount of colorant(s) in the panel depends on a variety of factors understood by a person having ordinary skill in the art without undue experimentation once the concept of a pre-determined color in a panel is known to be useful for causing a perceived color temperature shift of a LED. For example, the phr of colorant(s) can range from 0.0001 to 0.0005, if one is using a violet dye to shift perception of color temperature from a higher number to a lower number, such as from about 3300 K to about 2700-2800 K, which correlates in marketing from between “Bright White” and “Warm White” products toward the more desirable “Soft White” product without the cost of manufacturing LEDs which illuminate at about 2700-2800 K.

### Optional Additives

The compound of the present invention can include conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (www.elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

### Processing

The preparation of compounds of the present invention is uncomplicated. The compound of the present invention can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present invention.

### Panel of Thermoplastic Compounds

Regardless of the selection of ingredients identified above, the panels of the present invention need to be translucent to permit the passage of light emitted from the LED through the bulk of the panel to be perceived by a viewer on a side of the panel distant from the LED. For example, a ceiling lighting fixture could have one or more LEDs within the frame of the fixture with one side of the fixture facing the floor being a panel of the present invention. That panel needs to be translucent for the passage of light but also needs to be colored to alter the perception of color temperature from that actually emitted by the LED to a more desirable, different color temperature, such as moving from about 3300 K to about 2800 K.

As explained above, color matching is a technique known to those skilled in the art. In this invention, it can be used to adjust the color temperature of an LED from actual to perceived during transmission of the light through the panel.

Color matching to adjust color temperature is based on a pre-determined shift in color temperature within the panel by use of colorants, one which cannot be adjusted such as by using an electrochromic, photochromic, or thermochromic layer associated with the panel. So long as the actual color temperature is known and the desired perceived color temperature is known, then one can use colorants to shift the perceived color temperature as light travels through the passive thermoplastic panel.

The panel can be any size to accommodate any number of LEDS, whether the panel is vertical as a lighted wall sign or horizontal as a ceiling fixture. The length of a preferred panel can range from about 0.254 cm (0.1 inch) to about 3.04 m (10 feet) and preferably from about 2.54 (1 inch) to about 121 cm (4 feet). The width of a preferred panel can range from about 12.7 cm (5 inches) to about 3.04 m (10 feet) and preferably from about 2.54 (1 inch) to about 182 cm (6 feet).

The thickness of a panel can affect its translucency. Again, one having ordinary skill in the art without undue experimentation can determine the appropriate thickness of the panel through which the LED light travels. For example, the thickness of a panel can range from about 0.5 mm to about 10 mm and preferably from about 0.5 mm to about 5 mm.

Preferably, translucency or light transmission percent can range from about 30% to about 99% and preferably from about 50% to about 85% as measured using ASTM D1003.

Optionally, the panel can also be composed of ingredients such as inorganic fillers, acrylics and silicones or combinations of them to provide not only translucency but also diffusivity, in order to minimize an ability to identify the point source(s) of the LEDs.

Panels can be made using any conventional polymer shaping technique, including without limitation, extrusion, molding, calendering, thermoforming, casting, etc.

### USEFULNESS OF THE INVENTION

Panels can be placed between any LED and a viewer of that LED and be colored to alter the actual color temperature to a perceived color temperature. End uses for such panels include, without limitation, lighting fixtures of all types, backlit signage of all types, general illumination, display lighting, automotive, and mobile devices.

These panels improve the appearance of color temperature uniformity for LED light point sources where the point sources may not be manufactured to identical tight tolerances, or are produced from different LED manufacturers, thereby resulting color temperature variation from one LED point source to another. The panels can also provide to luminaire manufacturers the ability to tailor the luminaire light output to different color temperatures without having to change the LED point source used. This simplifies inventory management, reduces work in process (WIP), speeds up manufacturing of customized units and can optimize product design around a single type of light source as opposed to having to source multiple color temperature LED chips from potentially numerous suppliers. This would also allow end users to change color temperature after installation of the luminaire if so desired.

### EXAMPLES

Geon™ M7500 polyvinyl chloride compound was melt-mixed with 0.0004 phr of a Solvent Violet 13 anthroquinone dye made by Lanxess of Leverkusen, Germany and extruded in a thickness of 0.254 cm (0.1 inch), a width of 7.62 cm (3 inches), and a length of 15.24 cm (6 inches) to prepare a test panel. The panel was placed between a LED and a viewer of the panel surface opposite the LED. The panel had a light transmission of 37% as measured according to ASTM D1003. The LED had a 3320 K color temperature as measured using a Gigahertz-Optik HCT-99D Handheld Luminous Color Meter. Using the same Gigahertz-Optik HCT-99D Handheld Luminous Color Meter, the perceived color temperature was measured to be 2867 K, a shift of 453 K.

The test above was repeated at 0.00020, 0.00025, 0.00030, and 0.00035 with a perceived color temperature shift of 420, 324, 355, and 413 K, respectively. From this information, one having ordinary skill in the art can tailor the amount of Violet 13 dye colorant to a desired perceived color temperature for the viewer of the LED through the panel.

The invention is not limited to the above embodiments. The claims follow.

What is claimed is:

1. A panel, comprising:
(a) a thermoplastic resin and
(b) at least one colorant,
wherein the panel is translucent and intermediate between a light emitting diode and a viewer of the light emitting diode, and
wherein the panel is colored in a manner to cause a perception of a shift from one actual color temperature of the light emitting diode to another color temperature perceived by the viewer in the absence of any electrochromic, photochromic, or thermochromic material in the panel.

2. The panel of claim 1, wherein the panel is a passive layer having a pre- determined color to provide the shift in color temperature perceived by the viewer from a different color temperature as actually emitted by the light emitting diode.

3. The panel of claim 1, wherein the thermoplastic resin is selected from the group consisting of polyolefins, polyesters, polyacrylics, styrenics, polyamides, polyvinyl halides, and combinations thereof.

4. The panel of claim 3, wherein the thermoplastic resin is polyvinyl chloride resin.

5. The panel of claim 4, wherein the panel further comprises lubricant, stabilizer, antioxidant, filler, flame retardant, processing aid, or combination thereof mixed with the thermoplastic resin and the colorant to form a thermoplastic compound.

6. The panel of claim 1, wherein the colorant is selected from the group consisting of a pigment, a dye, a combination of pigments, a combination of dyes, a combination of pigments and dye, a combination of pigment and dyes, or a combination of pigments and dyes.

7. The panel of claim 3 wherein the panel has a thickness of 0.5 mm to about 10 mm.

8. The panel of claim 7, wherein the thickness is from about 0.5 mm to about 5 mm.

9. The panel of claim 6, wherein the panel has a thickness of 0.5 mm to about 10 mm.

10. The panel of claim 9, wherein the thickness is from about 0.5 mm to about 5 mm.

11. The panel of claim 10, wherein the panel further comprises inorganic fillers, acrylics, silicones, or combinations of them to provide diffusivity, in order to minimize an ability to identify a point source of the light emitting diode.

12. The panel of claim 2, wherein the thermoplastic resin is selected from the group consisting of polyolefins, polyesters, polyacrylics, styrenics, polyamides, polyvinyl halides, and combinations thereof.

13. The panel of claim 2, wherein the colorant is selected from the group consisting of a pigment, a dye, a combination of pigments, a combination of dyes, a combination of pigments and dye, a combination of pigment and dyes, or a combination of pigments and dyes.

14. The panel of claim 3, wherein the colorant is selected from the group consisting of a pigment, a dye, a combination of pigments, a combination of dyes, a combination of pigments and dye, a combination of pigment and dyes, or a combination of pigments and dyes.

15. The panel of claim 4, wherein the colorant is selected from the group consisting of a pigment, a dye, a combination of pigments, a combination of dyes, a combination of pigments and dye, a combination of pigment and dyes, or a combination of pigments and dyes.

16. The panel of claim 5, wherein the colorant is selected from the group consisting of a pigment, a dye, a combination of pigments, a combination of dyes, a combination of pigments and dye, a combination of pigment and dyes, or a combination of pigments and dyes.

17. The panel of claim 13, wherein the panel has a thickness of 0.5 mm to about 10 mm.

18. The panel of claim 14, wherein the panel has a thickness of 0.5 mm to about 10 mm.

19. The panel of claim 15, wherein the panel has a thickness of 0.5 mm to about 10 mm.

20. The panel of claim 16, wherein the panel has a thickness of 0.5 mm to about 10 mm.
